(19) United States
(12) Patent Application Publication
(10) Pub. No.: US 2024/0029089 A1
(43) Pub. Date: Jan. 25, 2024

(54) INFORMATION PROCESSING APPARATUS AND INFORMATION PROCESSING METHOD

(71) Applicant: Toshiba Tec Kabushiki Kaisha, Tokyo (JP)

(72) Inventor: Tetsuya ISHIDA, Sunto Shizuoka (JP)

(21) Appl. No.: 18/309,120

(22) Filed: Apr. 28, 2023

(30) Foreign Application Priority Data
Jul. 20, 2022 (JP) 2022-115254

(51) Int. Cl. G06Q 30/0202; G06Q 30/0282; G06Q 30/0204

(52) U.S. Cl. CPC G06Q 30/0202; G06Q 30/0282; G06Q 30/0205

(57) ABSTRACT

According to an embodiment, an information processing apparatus detects a product whose number of sales tends to increase in a wide area. The information processing apparatus acquires the number of searches of the product from a preset first information source. The information processing apparatus calculates a proportion of positive reviews about the product from reviews posted to the first information source. In addition, the information processing apparatus determines whether wide demand for the product can be expected on the basis of the acquired number of searches and the calculated proportion of the positive reviews.

### CROSS-REFERENCE TO RELATED APPLICATIONS

This application is based upon and claims the benefit of priority from the prior Japanese Patent Application No. 2022-115254, filed on Jul. 20, 2022, the entire contents of which are incorporated herein by reference.

### FIELD

An embodiment described here generally relates to an information processing apparatus and an information processing method.

### BACKGROUND

Conventionally, there is known an information processing apparatus that searches for information by using the product name of a product detected as having been sold better than usual as a keyword, acquires TV programs and pages of guide sites and news sites estimated to have contributed to the sales promotion, and displays them on a display of a POS terminal.

Desirably, a person in charge of products order early finds a product for which demand has increased suddenly after it has been introduced on TV or the like or a product for which demand has increased locally only in a region near a store, predicts that its demand will increase with a high possibility, and makes a suitable order. The conventional technologies allow estimation of an information source associated with an increase in sales. However, the conventional technologies cannot identify a reason why the number of sales has increased, and the person in charge of order cannot decide to increase the order quantity due to such insufficient information.

### BRIEF DESCRIPTION OF THE DRAWINGS

FIG. 1 is a block diagram showing a schematic configuration example of a demand forecasting system according to an embodiment.

FIG. 2 is a hardware block diagram showing an example of a hardware configuration of a demand forecasting apparatus of the demand forecasting system according to the embodiment.

FIG. 3 is a diagram showing a data structure example of number-of-product-sales data according to the embodiment.

FIG. 4 is a diagram showing a data structure example of specified-user purchase data according to the embodiment.

FIG. 5 is a diagram showing a data structure example of number-of-product-searches data according to the embodiment.

FIG. 6 is a diagram showing a data structure example of review classification data according to the embodiment.

FIG. 7 is a diagram showing a data structure example of demand forecasting data according to the embodiment.

FIG. 8 is a functional block diagram showing a functional configuration example of the demand forecasting apparatus according to the embodiment.

FIG. 9 is a diagram describing a method of predicting whether the demand forecasting apparatus according to the embodiment can expect future wide demand for a specified product.

FIG. 10 is a diagram describing a method of predicting whether the demand forecasting apparatus according to the embodiment can expect future demand for the specified product in a specified region.

FIG. 11 is a diagram showing an example of outputting a forecasting result of the demand forecasting apparatus to an order screen for the product according to the embodiment.

FIG. 12 is a diagram showing an example of a wide-region demand forecasting result output by the demand forecasting apparatus according to the embodiment.

FIG. 13 is a diagram showing an example of a local demand forecasting result output by the demand forecasting apparatus according to the embodiment.

FIG. 14 is a flowchart showing an example of a flow of processing performed by the demand forecasting apparatus according to the embodiment.

FIG. 15 is a flowchart showing an example of a flow of processing of wide demand forecasting according to the embodiment.

FIG. 16 is a flowchart showing an example of a flow of processing local demand forecasting according to the embodiment.

### DETAILED DESCRIPTION

In accordance with one embodiment, an information processing apparatus forecasts demand for a product. The information processing apparatus includes a storage device, a communication interface, and a controller. The storage device stores product sales data. The product sales data includes data necessary for comparing the number of current product sales with the number of past product sales with respect to a plurality of products. The communication interface accesses a preset first information source. The first information source is an information source where a plurality of users is able to search for a product and post reviews about the product. The controller detects, on the basis of the product sales data, a product whose number of sales tends to increase in a wide area by comparing the number of current product sales with the number of past product sales. The controller acquires the number of searches of the detected product from the first information source via the communication interface. The controller calculates a proportion of positive reviews about the detected product in the reviews posted to the first information source. The controller determines whether demand for the product in the wide area can be expected on the basis of the acquired number of searches and the calculated proportion of the positive reviews. In addition, the controller outputs a result of the determination.

Hereinafter, an information processing apparatus, an information processing method, and the like according to an embodiment will be described with reference to the drawings. In the drawings, the same reference signs denote the same or similar portions. Specifically, a demand forecasting system 10 to which the information processing apparatus and the information processing method according to the embodiment are applied will be described with reference to the drawings.

(Schematic Configuration of Demand Forecasting System)

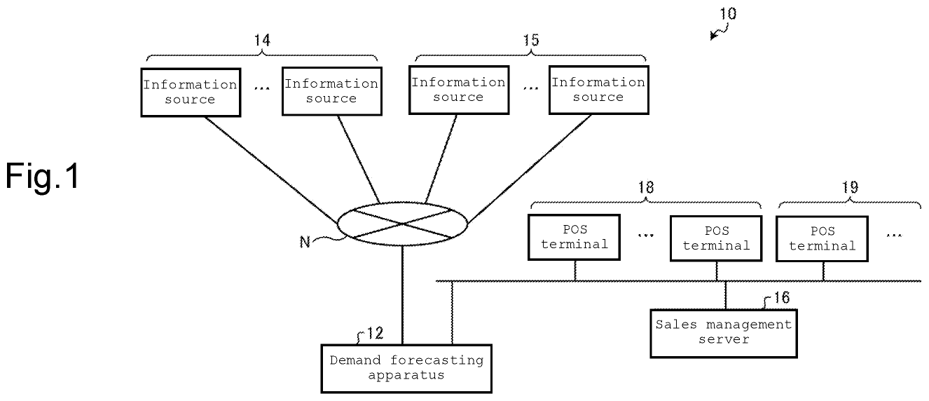

A schematic configuration of the demand forecasting system 10 will be described with reference to FIG. 1. FIG. 1 is a block diagram showing a schematic configuration example of the demand forecasting system.

The demand forecasting system 10 forecasts a product for which demand can increase in a wide area. Moreover, the demand forecasting system 10 forecasts a product for which demand can increase in a limited region (local region) such as a specified region. The demand forecasting system 10 includes a demand forecasting apparatus 12, first information sources 14 and second information sources 15, a sales management server 16, and POS terminals 18 and POS terminals 19. The first information sources 14 and second information sources 15 are located in a network N such as the Internet connected to the demand forecasting apparatus 12. The sales management server 16 is connected to the demand forecasting apparatus 12 via the network N. The POS terminals 18 and POS terminals 19 are connected to the sales management server 16 via a network such as a LAN.

The demand forecasting apparatus 12 forecasts a product for which demand can increase in a wide area (hereinafter, referred to as wide demand forecasting) on the basis of information from the first information sources 14 connected to the network N and product sales information from the sales management server 16. Moreover, the demand forecasting apparatus 12 forecasts a product for which demand can increase in a specified region (hereinafter, referred to as local demand forecasting) on the basis of information from the second information sources 15 connected to the network N and product sales information from the POS terminals 18. It should be noted that the demand forecasting apparatus 12 is an example of an information processing apparatus in the present embodiment.

An operator of the demand forecasting system 10 orders products by referring to forecasting results of the demand forecasting apparatus 12. Hereinafter, the demand forecasting apparatus 12 having such a product order function will be described.

The first information sources 14 include, for example, social networking service (SNS) sites such as homepages, search services, image post sites, video post sites, and message post sites accessible via the network N. In particular, the first information sources 14 are information sources expected to be accessed widely from a whole country and not limited to a region.

The second information sources 15 are for example homepages of a municipal office A, a school B, and the like specialized for a specified region, which are accessible via the network N. That is, the second information sources 15 are information sources expected to be often accessed from a specified region.

The POS terminals 18 are terminal devices that are installed in stores in a preset specified region and manage product sales.

The POS terminals 19 are terminal devices that are installed in regions other than the specified region and manage product sales.

The sales management server 16 is a server device that comprehensively manages the POS terminals 18 and the POS terminals 19. The sales management server 16 acquires and manages product sales information of the POS terminals 18 and the POS terminals 19. It should be noted that for example, a plurality of sales management servers 16 that each comprehensively manages the POS terminals for each region may be provided other than the single sales management server 16.

(Hardware Configuration of Demand Forecasting Apparatus)

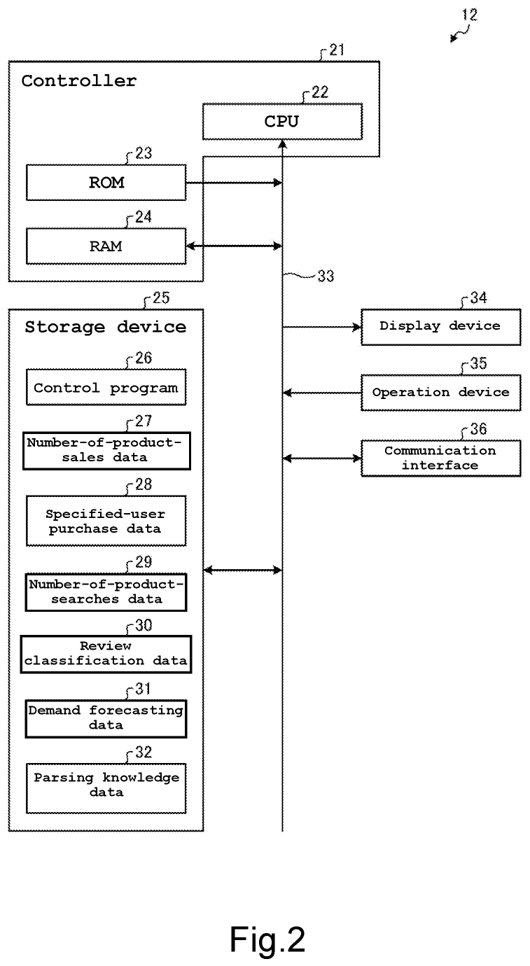

A hardware configuration of the demand forecasting apparatus 12 will be described with reference to FIG. 2. FIG. 2 is a hardware block diagram showing a hardware configuration example of the demand forecasting apparatus of the demand forecasting system.

The demand forecasting apparatus 12 includes a controller 21 for controlling the respective blocks of the demand forecasting apparatus 12. The controller 21 includes a processor 22, a read only memory (ROM) 23, and a random access memory (RAM) 24. The processor 22 is for example a central processing unit (CPU). Hereinafter, the processor 22 will be referred to as the CPU 22. The CPU 22 connects the ROM 23 and the RAM 24 via an internal bus 33 such as address bus and data bus. The CPU 22 deploys various programs stored in the ROM 23 and a storage device 25 to the RAM 24. The CPU 22 controls the operation of the demand forecasting apparatus 12 by operating in accordance with the various programs deployed to the RAM 24. That is, the controller 21 has a general computer configuration.

The controller 21 connects the storage device 25, a display device 34, an operation device 35, and a communication interface 36 via the internal bus 33.

The storage device 25 is a storage device such as a hard disk drive (HDD) and a solid state drive (SSD). Moreover, the storage device 25 may be a nonvolatile memory such as a flash memory that keeps stored information even when it is powered off. The storage device 25 stores a control program 26 necessary for the demand forecasting apparatus 12 to perform a predetermined operation and various types of data necessary for the demand forecasting apparatus 12 to perform various demand forecasting, e.g., number-of-product-sales data 27, specified-user purchase data 28, number-of-product-searches data 29, review classification data 30, demand forecasting data 31, and parsing knowledge data 32.

The control program 26 is a program for controlling the general operation of the demand forecasting apparatus 12.

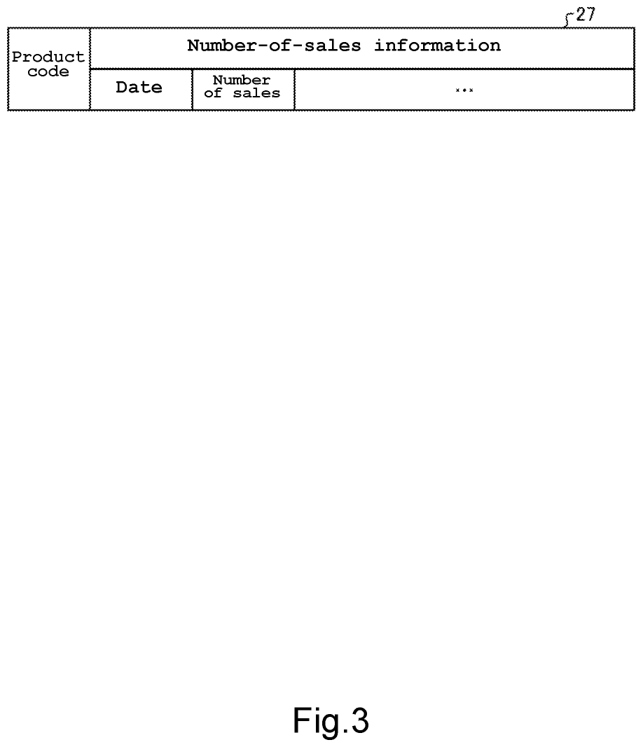

The number-of-product-sales data 27 is data recording the number of sales of the product in, e.g., a whole country for each product code, for each date. The sales management server 16 sums up the number of sales of the product. A data structure of the number-of-product-sales data 27 will be described later in detail (see FIG. 3).

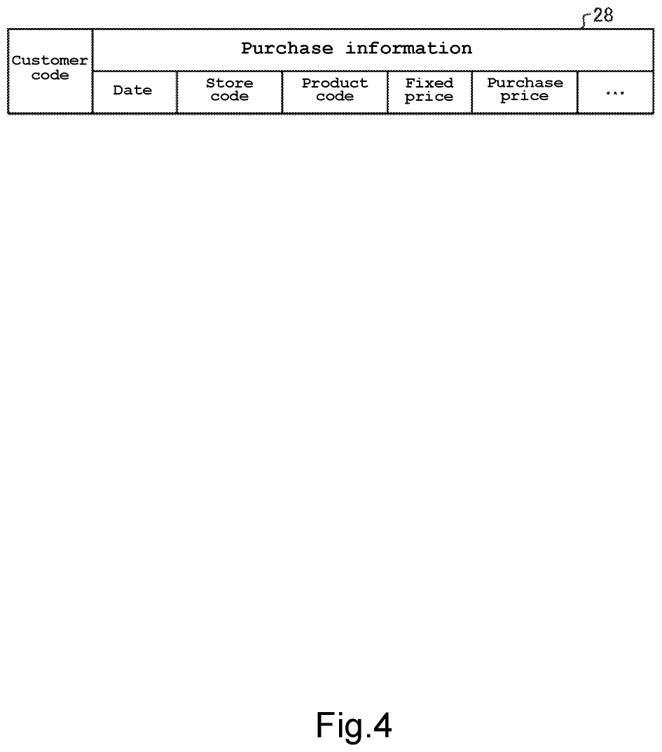

The specified-user purchase data 28 is for example product purchase data of users living in the specified region. Here, the specified-user purchase data 28 in the present embodiment is purchase data of some of users of an application that allows electronic product registration and settlement for purchasing products in stores with their portable terminals, whose addresses declared in use registration of the application correspond to the specified region. A data structure of the specified-user purchase data 28 will be described later in detail (see FIG. 4). It should be noted that the scope of the specified-user purchase data 28 is not limited thereto, and for example, the specified-user purchase data 28 may be product purchase data of all users at a specified store in the specified region.

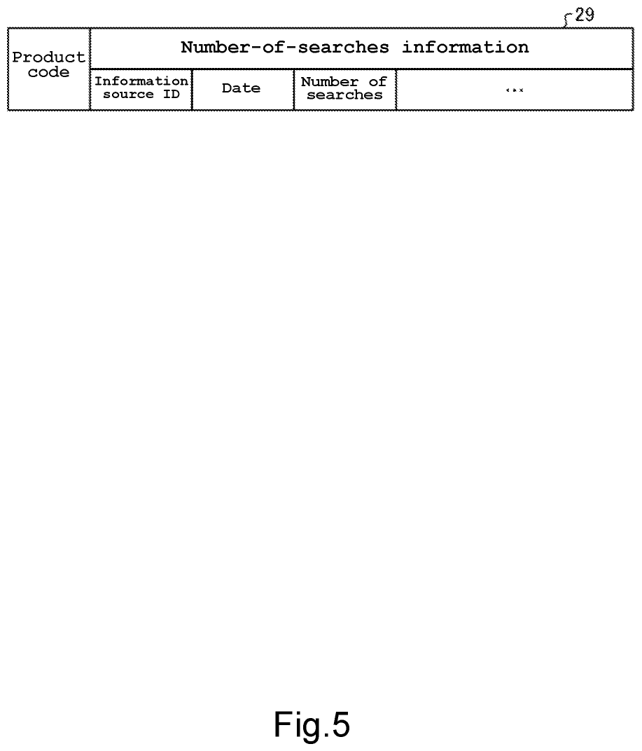

The number-of-product-searches data 29 is data recording, for each date, the number of searches of the product whose number of sales tends to increase. It should be noted that the information sources as targets to be searched are the first information sources 14 and the second information sources 15 described above. A data structure of the number-of-product-searches data 29 will be described later in detail (see FIG. 5).

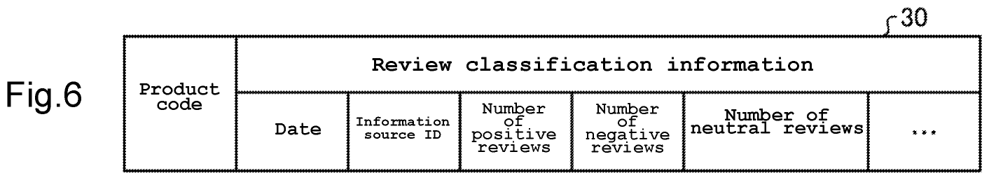

The review classification data 30 is data identifying the contents of the reviews sent to the first information sources 14 and the second information sources 15 with respect to the product whose number of sales tends to increase. More specifically, the review classification data 30 indicates results identifying that each of the reviews sent with respect to the product whose number of sales tends to increase is positive, negative, or neutral. A data structure of the review classification data 30 will be described later in detail (see FIG. 6).

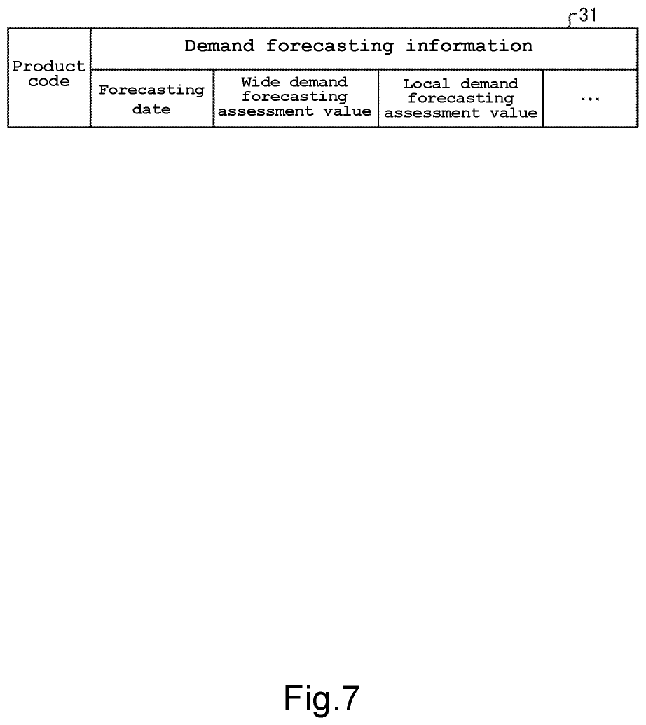

The demand forecasting data 31 is data recording results of assessing whether wide demand for the product can be expected or demand for the product in the specified region can be expected with respect to the product whose number of sales tends to increase. A data structure of the demand forecasting data 31 will be described later in detail (see FIG. 7).

The parsing knowledge data 32 is data used for identifying the contents of the reviews sent to the first information sources 14 and the second information sources 15. In order to analyze a structure of a text describing a review, the parsing knowledge data 32 includes a rule for dividing the text into words, a rule for analyzing dependency relations between the divided words, and a rule for identifying whether the review is positive or negative. It should be noted that the detailed description of parsing will be omitted because it is a generally widely used technique such as analysis of the contents of comments sent to a webpage.

The display device 34 displays a screen generated in accordance with an instruction from the controller 21. The display device 34 is a device, e.g., a liquid crystal display (LCD) or organic electro-luminescence (EL).

The operation device 35 acquires an input operation from the operator and sends it to the controller 21. The operation device 35 is a device, e.g., a touch panel or keyboard.

The communication interface 36 is an interface for accessing the first information sources 14 and the second information sources 15 via the network N. Moreover, the communication interface 36 is an interface for accessing the POS terminals 18, the POS terminals 19, and the sales management server 16.

(Data Structure of Number-of-Product-Sales Data)

A data structure of the number-of-product-sales data 27 will be described with reference to FIG. 3. FIG. 3 is a diagram showing a data structure example of the number-of-product-sales data.

The number-of-product-sales data 27 is data describing, for each product code uniquely identifying the product, the date and the number of sales in association with each other as shown in FIG. 3.

It should be noted that the demand forecasting apparatus 12 acquires number-of-sales information from the sales management server 16.

(Data Structure of Specified-User Purchase Data)

A data structure of the specified-user purchase data 28 will be described with reference to FIG. 4. FIG. 4 is a diagram showing a data structure example of the specified-user purchase data.

The specified-user purchase data 28 is data describing purchase information of the customer for each customer code uniquely identifying a customer whose address is within the specified region as shown in FIG. 4.

The purchase information includes a date when the customer has purchased a product, a store code of a store where the customer has purchased the product, a product code of the purchased product, and a fixed price and a purchase amount of the purchased product.

(Data Structure of Number-of-Product-Searches Data)

A data structure of the number-of-product-searches data 29 will be described with reference to FIG. 5. FIG. 5 is a diagram showing a data structure example of the number-of-product-searches data.

The number-of-product-searches data 29 is data describing number-of-searches information of the product with the product code for each product code uniquely identifying the product as shown in FIG. 5.

The number-of-searches information includes an information source ID uniquely identifying an information source for search, a date when the search has been performed, and the number of searches. The information source ID is identification information uniquely identifying the first information sources 14 and the second information sources 15.

(Data Structure of Review Classification Data)

A data structure of the review classification data 30 will be described with reference to FIG. 6. FIG. 6 is a diagram showing a data structure example of the review classification data.

The review classification data 30 is data describing review identification information identifying a review according to a product post to the information source for each product code uniquely identifying the product as shown in FIG. 6.

The review identification information includes a date when the review has been posted, an information source ID uniquely identifying the information source to which the review has been posted, and the number of positive reviews, the number of negative reviews, and the number of neutral reviews.

(Data Structure of Demand Forecasting Data)

A data structure of the demand forecasting data 31 will be described with reference to FIG. 7. FIG. 7 is a diagram showing a data structure example of the demand forecasting data.

The demand forecasting data 31 is data describing demand forecasting information indicating a result of product demand forecasting for each product code uniquely identifying the product as shown in FIG. 7.

The demand forecasting information includes a forecasting date when demand forecasting has been performed, a wide demand forecasting assessment value, and a local demand forecasting assessment value.

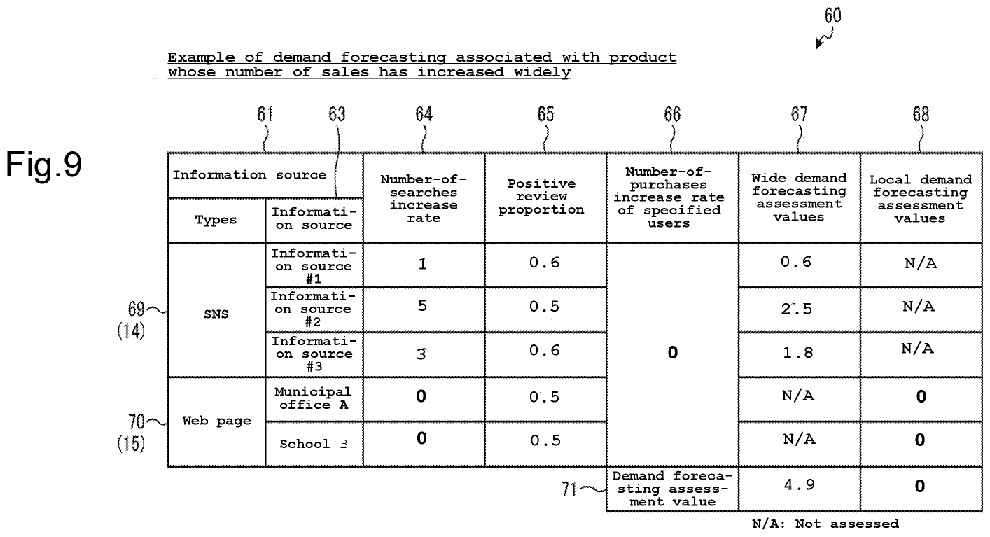

The wide demand forecasting assessment value is an assessment value indicating a result of predicting whether future wide demand can be expected. The wide demand forecasting assessment value will be described later in detail (see FIG. 9).

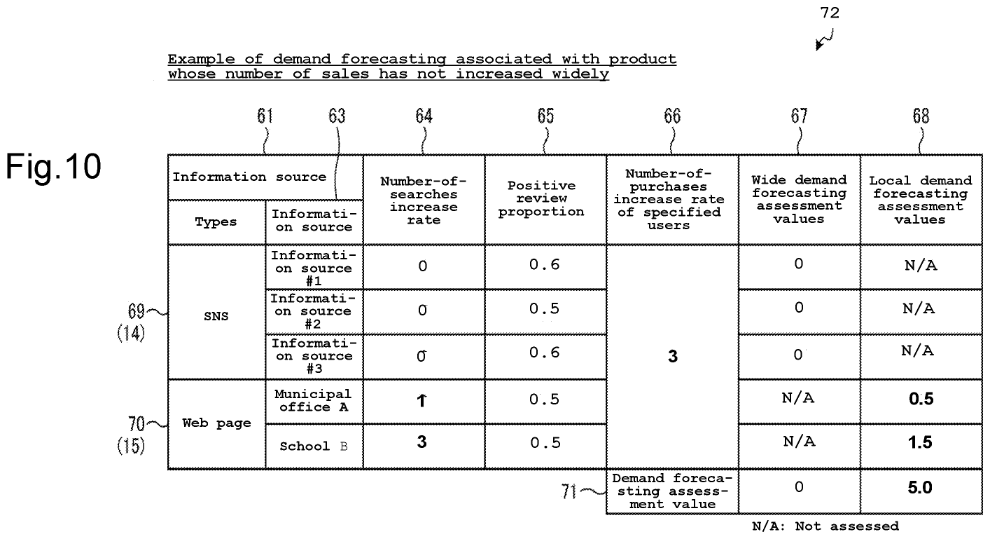

The local demand forecasting assessment value is an assessment value indicating a result of predicting whether future demand in the specified region can be expected. The local demand forecasting assessment value will be described later in detail (see FIG. 10).

(Functional Configuration of Demand Forecasting Apparatus)

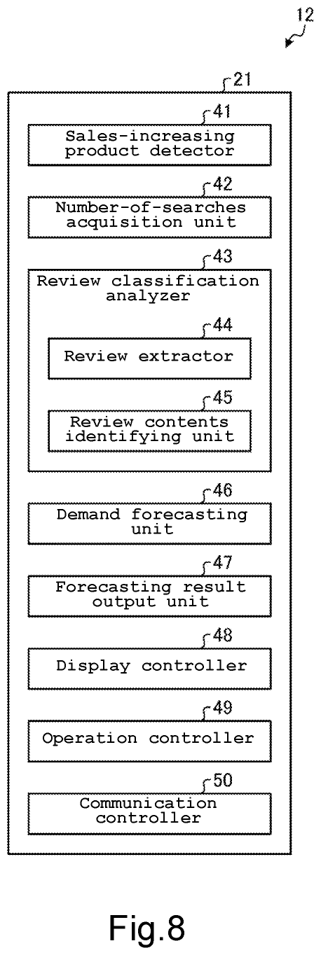

The description will be made with reference to FIG. 8. FIG. 8 is a functional block diagram showing an example of a functional configuration of the demand forecasting apparatus.

The controller 21 of the demand forecasting apparatus 12 operates as functional blocks shown in FIG. 8, i.e., a sales-increasing product detector 41, a number-of-searches acquisition unit 42, a review classification analyzer 43, a demand forecasting unit 46, a forecasting result output unit 47, a display controller 48, an operation controller 49, and a communication controller 50 by deploying the control program 26 to the RAM 24 for operating it. It should be noted that dedicated hardware may achieve some or all of the functional blocks.

The sales-increasing product detector 41 detects a product (first product) whose number of sales tends to increase widely. Moreover, the sales-increasing product detector 41 detects a product (second product) whose number of sales tends to increase with respect to specified users in the specified region. It should be noted that the sales-increasing product detector 41 is an example of a detector in the present embodiment. Specifically, with respect to a product of interest, the sales-increasing product detector 41 determines whether the number of sales tends to increase by comparing the number of current sales with the number of past sales (e.g., an average number of sales recorded several years before, one year before, several weeks before, or several days before).

The number-of-searches acquisition unit 42 acquires the number of searches of the first product from the preset first information sources 14. Moreover, the number-of-searches acquisition unit 42 acquires the number of searches of the second product from the preset second information sources 15 that transmit information associated with the specified region. Moreover, the number-of-searches acquisition unit 42 digitizes an increase rate of the acquired number of searches. It should be noted that the number-of-searches acquisition unit 42 is an example of an acquisition unit in the present embodiment.

The review classification analyzer 43 calculates a proportion of positive reviews about the first product on the basis of the reviews sent to the first information sources 14 or the second information sources 15. Moreover, the review classification analyzer 43 calculates a proportion of positive reviews about the second product on the basis of the reviews sent to the second information source. It should be noted that the review classification analyzer 43 is an example of a calculator in the present embodiment.

It should be noted that the review classification analyzer 43 further includes a review extractor 44 and a review contents identifying unit 45.

The review extractor 44 extracts a review associated with the specified product from the reviews sent to the first information sources 14. Moreover, the review extractor 44 extracts the review associated with the specified product from the reviews sent to the second information sources 15. The specified product includes the first product whose number of sales tends to increase widely or the second product whose number of sales tends to increase with respect to the specified users in the specified region, which the sales-increasing product detector 41 has detected. More specifically, the review extractor 44 extracts a review including the name of the specified product from the reviews sent to the first information sources 14 or the second information sources 15. The review extractor 44 is an example of an extractor in the present embodiment.

The review contents identifying unit 45 identifies whether the review is positive, negative, or neutral by parsing the review extracted by the review extractor 44. More specifically, the review contents identifying unit 45 identifies whether the review is positive or negative or neutral to the specified product by analyzing a dependency relation structure of the review extracted by the review extractor 44. The review contents identifying unit 45 is an example of an identifying unit in the present embodiment.

It should be noted that the review contents identifying unit 45 may use a model learned in advance for the identification. The model learned in advance is for example a model for receiving inputs of the contents of the review and the product name of the product of interest and outputting an assessment value of a positive review about the product, an assessment value of a negative review about the product, or an assessment value of a review that is neutral.

The demand forecasting unit 46 determines whether wide demand for the first product can be expected on the basis of the number of searches acquired by the number-of-searches acquisition unit 42 and the proportion of positive reviews calculated by the review classification analyzer 43. Moreover, the demand forecasting unit 46 determines whether demand for the second product in the specified region can be expected on the basis of the number of searches acquired by the number-of-searches acquisition unit 42 and the proportion of positive reviews calculated by the review classification analyzer 43.

The forecasting result output unit 47 outputs the determination result of the demand forecasting unit 46. It should be noted that the forecasting result output unit 47 is an example of an output unit in the present embodiment.

The display controller 48 generates screen information displayed on the display device 34 and controls the display of the display device 34.

The operation controller 49 acquires operation information about an operation performed on the operation device 35 and sends it to the controller 21.

The communication controller 50 controls communication between the demand forecasting apparatus 12, the POS terminals 18 and the POS terminals 19, and the sales management server 16.

(Description of Wide-Range Demand Forecasting Method)

A method of predicting whether future wide demand for the specified product whose number of sales tends to increase widely can be expected will be described with reference to FIG. 9. FIG. 9 is a diagram describing a method of predicting whether the demand forecasting apparatus can expect future wide demand for the specified product. Hereinafter, predicting whether future wide demand for the specified product can be expected will be referred to as wide demand forecasting.

As to a product whose number of sales tends to increase widely, which the sales-increasing product detector 41 has detected, the demand forecasting unit 46 acquires and analyzes a number-of-searches increase rate 64 of the product in information sources 61, a posted positive review proportion 65, and a number-of-purchases increase rate 66 of the specified users. In this manner, the demand forecasting unit 46 generates a demand forecasting assessment sheet 60 shown in FIG. 9.

It should be noted that whether the product whose number of sales tends to increase widely is determined for example on the basis of whether the rate of increase in number of sales is above a predetermined threshold as a result of analyzing the contents of the number-of-product-sales data 27 and comparing the number of current sales with the number of past sales.

The information sources 61 are an item obtained by rearranging the first information sources 14 and the second information sources 15 for each specific information source. The example of FIG. 9 shows various SNS sites 69 as the first information sources 14. It also shows a plurality of information sources 63 as specific examples of the SNS sites 69. The information sources 63 include, for example, image post sites, video post sites, message post sites, and influencers' personal sites. FIG. 9 shows information sources #1, #2, and #3 as the information sources 63.

The example of FIG. 9 also shows various webpages 70 as the second information sources 15. It also shows a plurality of information sources 63 as specific examples of the webpages 70. The information sources 63 are webpages and the like describing information about the specified region. FIG. 9 shows municipal office A and school B as the information sources 63.

It should be noted that the types of information sources 61 can also include various search service sites, trend analysis sites, and the like other than the SNS and webpages.

The number-of-searches increase rate 64 is an item obtained by digitizing a number-of-searches increase rate in each information source 63 of the information sources 61 with respect to the product whose number of sales tends to increase widely. Specifically, a change in number of searches is read at predetermined time intervals (e.g., every other day or every other month) from the number-of-product-searches data 29. Then, an assessment value of 1, 3, or 5 for example is applied in accordance with the number-of-searches increase rate. Moreover, the assessment value is zero in a case where the number of searches has not changed or has decreased.

The positive review proportion 65 is an item showing proportion of positive reviews in the contents of the reviews posted to an information source that is each of the information sources 63 included in the first information sources 14. Specifically, an assessment value (0.0 to 1.0) is applied depending on the proportion of positive reviews to the number of posts in a predetermined period in the above-mentioned review classification data 30.

The number-of-purchases increase rate 66 of the specified users is an item showing an increase rate of the number of purchases of the specified product with respect to the specified users in the specified region. Assessment values in such an item will be described later in detail because the item is used for local demand forecasting (see FIG. 10).

The demand forecasting unit 46 calculates wide demand forecasting assessment values 67 and local demand forecasting assessment values 68 on the basis of such acquired information. The wide demand forecasting assessment values 67 are assessment values indicating whether wide demand for the product of interest can be expected. The wide demand forecasting assessment values 67 are values obtained by adding the number-of-searches increase rate 64 and the positive review proportion 65.

The local demand forecasting assessment values 68 are not applied in FIG. 9 because they are an assessment item applied to a product whose number of sales does not tend to increase widely. The contents of such an item will be described later in detail (see FIG. 10).

The demand forecasting unit 46 analyzes a calculation result of the wide demand forecasting assessment values 67 and determines whether wide demand for the product of interest can be expected. For example, the demand forecasting unit 46 calculates a demand forecasting assessment value 71 by adding all the wide demand forecasting assessment values 67, and determines that wide demand for the product of interest can be expected in a case where the demand forecasting assessment value 71 is equal to or higher than a threshold. That is, the demand forecasting assessment value 71 in this case represents a wide demand forecasting assessment value. In the example of FIG. 9, the demand forecasting assessment value 71 obtained by adding all the wide demand forecasting assessment value 67 is 4.9. A threshold for determining that the wide demand for the product of interest can be expected is for example set to 4.5. Then, the demand forecasting unit 46 uses this threshold for determining that the wide demand for the product of interest can be expected.

It should be noted that an average value of all the wide demand forecasting assessment values 67 may be used as the demand forecasting assessment value 71 because the demand forecasting assessment value 71 increases along with an increase in number of information sources 63 in this determination method.

Moreover, a method of determining whether the wide demand can be expected is not limited thereto. For example, in a case where at least one of the wide demand forecasting assessment values 67 with respect to the plurality of information sources 63 is above a predetermined value, the demand forecasting unit 46 may determine that wide demand for the product of interest can be expected.

(Description of Local Demand Forecasting Method)

A method of predicting whether future demand for the specified product in the specified region can be expected will be described with reference to FIG. 10. FIG. 10 is a diagram describing the method of predicting whether the demand forecasting apparatus can expect future demand for the specified product in the specified region. Hereinafter, predicting whether future demand for the specified product in the specified region can be expected will be referred to as local demand forecasting.

A demand forecasting assessment sheet 72 shown in FIG. 10 is an example of demand forecasting associated with a product whose number of sales does not tend to increase widely as a determination result of the sales-increasing product detector 41. The description contents of the respective items of the demand forecasting assessment sheet 72 are the same as the demand forecasting assessment sheet 60 (see FIG. 9).

The number-of-searches increase rate 64 shown in FIG. 10 indicates that the number of searches for the specified product of interest in the first information sources 14 has not increased while the number of searches for the specified product of interest in the second information sources 15 has increased.

The positive review proportion 65 is an item showing the proportion of positive reviews in the contents of the reviews posted to each of the information sources 63 included in the second information sources 15. Specifically, an assessment value (0.0 to 1.0) is applied depending on the proportion of positive reviews to the number of posts in a predetermined period in the above-mentioned review classification data 30.

The number-of-purchases increase rate 66 of the specified users indicates that the number of purchases of the specified product by the specified users in the specified region has rapidly increased. It should be noted that for example, the assessment value “1” is applied in a case where the number-of-purchases increase rate 66 of the specified users has increased from that one month before, and the assessment value “3” is applied in a case where it has rapidly increased.

The wide demand forecasting assessment values 67 are not applied in FIG. 10 because they are assessment values regarding the product whose number of sales tends to increase widely.

The local demand forecasting assessment values 68 are assessment values indicating whether demand for the product of interest in the specified region can be expected. The local demand forecasting assessment values 68 are values obtained by adding the number-of-searches increase rate 64 and the positive review proportion 65.

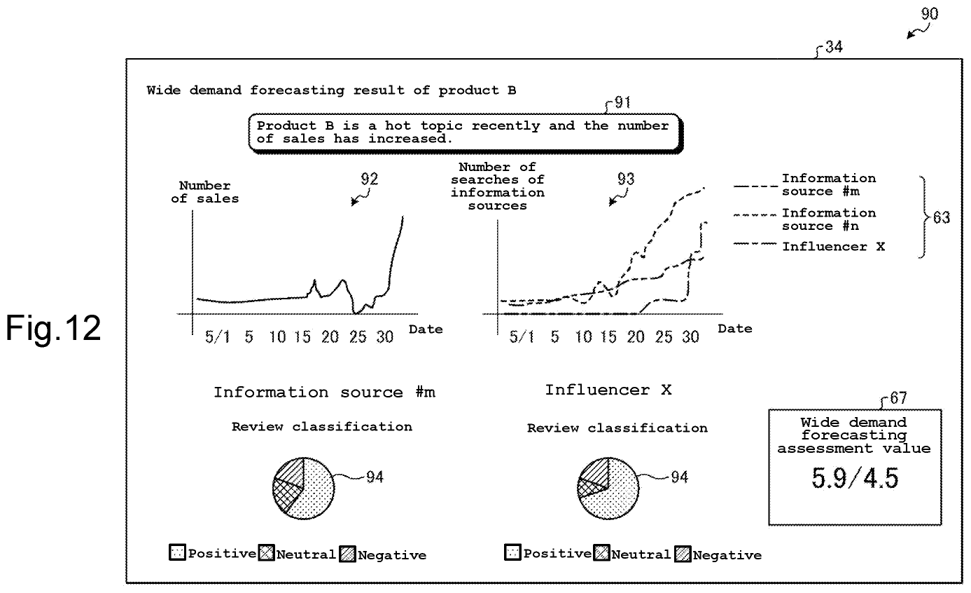

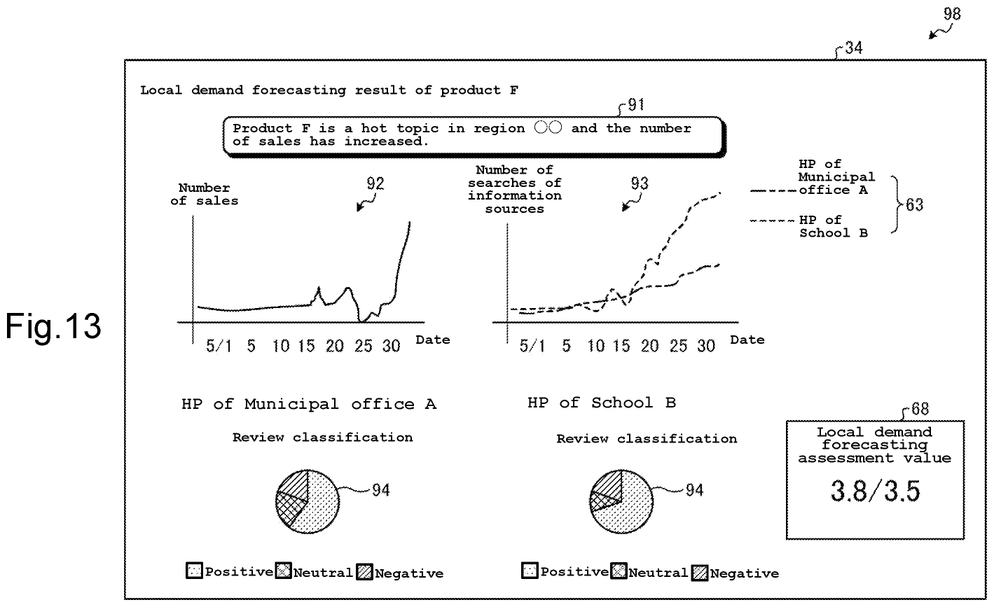

The demand forecasting unit 46 determines whether demand for the product of interest in the specified region can be expected by analyzing a calculation result of the local demand forecasting assessment values 68. For example, the demand forecasting unit 46 calculates a demand forecasting assessment value 71 by adding up all the local demand forecasting assessment values 68 and further adding the number-of-purchases increase rate 66 of the specified users to the addition result. Then, the demand forecasting unit 46 determines that the demand for the product of interest in the specified region can be expected in a case where the demand forecasting assessment value 71 is equal to or higher than a threshold. That is, the demand forecasting assessment value 71 in this case represents a local demand forecasting assessment value. In the example of FIG. 10, the demand forecasting assessment value 71 is 5.0 as a result of adding the assessment value of 3.0 of the number-of-purchases increase rate 66 of the specified users to the assessment value of 2.0 obtained by adding all the local demand forecasting assessment values 68. Then, in a case where a threshold for determining that the demand for the product of interest in the specified region can be expected is, for example, set to 3.5, the demand forecasting unit 46 uses this threshold for determining that the local demand for the product of interest can be expected. Moreover, in a case where the demand forecasting unit 46 determines that the wide demand can be expected, the demand forecasting unit 46 generates a wide demand forecasting screen 90 (see FIG. 12) showing the determination result. Moreover, in a case where the demand forecasting unit 46 determines that the local demand can be expected, the demand forecasting unit 46 generates a local demand forecasting screen 98 (see FIG. 13) showing the determination result.

It should be noted that a value obtained by adding the number-of-purchases increase rate 66 of the specified users to an average value of all the local demand forecasting assessment values 68 may be used as the demand forecasting assessment value 71 because the demand forecasting assessment value 71 increases along with an increase in the number of information sources 63 in this determination method.

Moreover, a method of determining whether the local demand can be expected is not limited thereto. For example, in a case where a value obtained by adding at least one of the local demand forecasting assessment values 68 with respect to the plurality of information sources 63 to the number-of-purchases increase rate 66 is above a predetermined value, the demand forecasting unit 46 may determine that the local demand for the product of interest can be expected.

### Output Example of Demand Forecasting Result

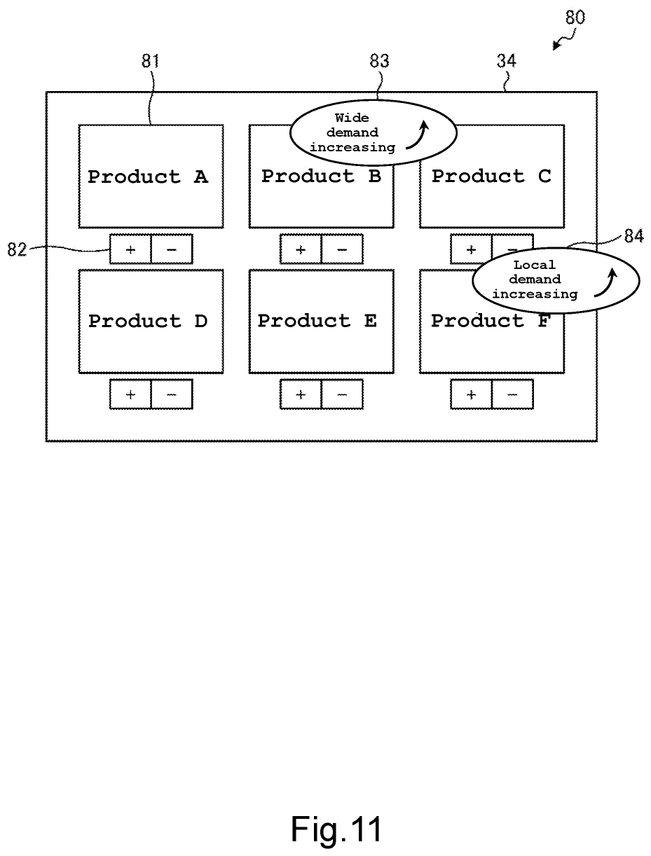

An output example of a demand forecasting result output by the demand forecasting apparatus 12 will be described with reference to FIGS. 11, 12, and 13. FIG. 11 is a diagram showing an example of outputting a forecasting result of the demand forecasting apparatus to an order screen for the product. FIG. 12 is a diagram showing an example of a wide-region demand forecasting result output by the demand forecasting apparatus. FIG. 13 is a diagram showing an example of a local demand forecasting result output by the demand forecasting apparatus.

A product order screen 80 displayed on the display device 34 of the demand forecasting apparatus 12 displays product display fields 81, a number-of-orders setting key 82, a wide demand increase mark 83, and a local demand increase mark 84.

The product display fields 81 show information indicating products to be ordered, e.g., product names and images.

The number-of-orders setting key 82 is a button for designating the number of orders of the product. Pressing the plus-key increases the number of orders in accordance with the number of presses. Moreover, pressing the minus-key reduces the number of orders in accordance with the number of presses. Although not shown in the figure, the designated number of orders is displayed, superimposed on the product display fields 81, for example.

The wide demand increase mark 83 is displayed, superimposed on the product display field 81 for a product for which wide demand is predicted to increase by the demand forecasting apparatus 12.

The local demand increase mark 84 is displayed, superimposed on the product display field 81 for a product for which local demand is predicted to increase by the demand forecasting apparatus 12.

The example of FIG. 11 shows that the wide demand for the product B is predicted to increase and the local demand for a product F is predicted to increase.

It should be noted that although not shown in FIG. 11, the product order screen 80 further shows various operation buttons such as a page feed button for shifting to a page where other products are displayed, an order instruction button for making an order with the set number of orders, and a cancellation button for cancelling the set number of orders.

The wide demand increase mark 83 and the local demand increase mark 84 also function as the operation buttons. Pressing the wide demand increase mark 83 displays on the display device 34 the wide demand forecasting screen 90 associated with the product B shown in FIG. 12. Moreover, pressing the local demand increase mark 84 displays on the display device 34 the local demand forecasting screen 98 associated with the product F shown in FIG. 13.

The wide demand forecasting screen 90 is a screen including a result obtained by the demand forecasting apparatus 12 performing wide demand forecasting on the product (first product) whose number of sales tends to increase widely, and a reason why the demand forecasting unit 46 has determined that wide demand for the product can be expected.

The wide demand forecasting screen 90 includes, as shown in FIG. 12, a determination reason 91 why the demand forecasting unit 46 has determined that wide demand for the product can be expected, a product sales transition 92, a number-of-searches transition 93 associated with the product, a review classification breakdown 94, and a wide demand forecasting assessment value 67.

The determination reason 91 is words briefly summarizing a reason why the demand forecasting unit 46 has determined that the wide demand for the product of interest can be expected. The example of FIG. 12 shows words expressing the fact that the number of searches for the product B has recently increased and the fact that the number of sales has recently increased.

The product sales transition 92 is a graph showing a transition of sales of the product whose number of sales tends to increase widely, which the sales-increasing product detector 41 has detected.

The number-of-searches transition 93 is a graph showing a transition of the number of searches for each information source 63, which the number-of-searches acquisition unit 42 has calculated.

The review classification breakdown 94 is a graph showing a breakdown of review classifications (positive, negative, and neutral reviews) calculated by the review classification analyzer 43 for each information source 63 to which reviews can be posted. It should be noted that the review classification breakdown 94 only needs to include at least the proportion of positive reviews. That is, the review classification breakdown 94 may be a numeric value indicating the proportion of positive reviews.

The wide demand forecasting assessment values 67 are assessment values indicating whether wide demand for the product of interest can be expected, which the demand forecasting unit 46 has calculated. It should be noted that the wide demand forecasting assessment values 67 are desirably displayed together with the threshold for determining that the wide demand can be expected as shown in FIG. 12.

The local demand forecasting screen 98 is a screen including a result obtained by the demand forecasting apparatus 12 performing local demand forecasting on the product (second product) whose number of sales tends to increase with respect to the specified users in the specified region and a reason why the demand forecasting unit 46 has determined that wide demand for the product can be expected.

The local demand forecasting screen 98 includes, as shown in FIG. 13, a determination reason 91 why the demand forecasting unit 46 has determined that wide demand for the product can be expected, a product sales transition 92, a number-of-searches transition 93 associated with the product, a review classification breakdown 94, and a local demand forecasting assessment value 68.

The determination reason 91 is words briefly summarizing a reason why the demand forecasting unit 46 has determined that the demand in the specified region can be expected with respect to the product of interest. The example of FIG. 13 shows words expressing the fact that the number of searches for the product F has recently increased and the fact that the number of sales has recently increased in the specified region.

The product sales transition 92, the number-of-searches transition 93 associated with the product, and the review classification breakdown 94 are as described above with reference to FIG. 12.

The local demand forecasting assessment value 68 is an assessment value indicating whether the demand for the product of interest in the specified region can be expected, which the demand forecasting unit 46 has calculated. It should be noted that the local demand forecasting assessment value 68 is desirably displayed together with the demand in the specified region can be expected and the threshold for determining as shown in FIG. 13. It should be noted that the threshold for determining that the wide demand can be expected, which is shown in FIG. 12, and the threshold for determining that the demand in the specified region can be expected, which is shown in FIG. 13, are not the same as shown in FIGS. 12 and 13 because they are independently set based on past demand forecasting results and the like.

(Flow of Processing Performed by Demand Forecasting Apparatus)

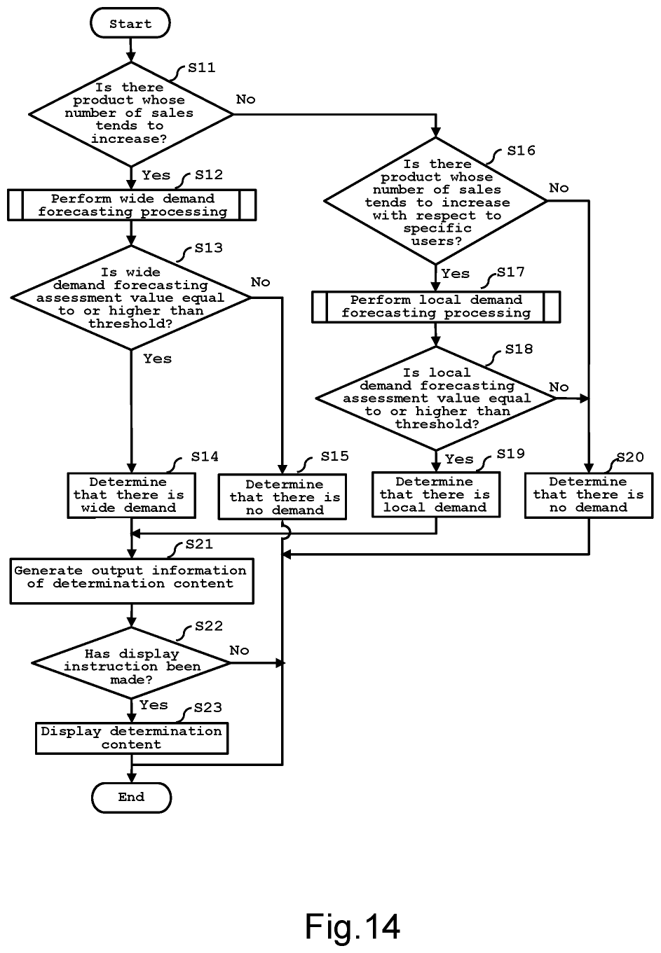

A flow of processing performed by the controller 21 of the demand forecasting apparatus 12 will be described with reference to FIG. 14. FIG. 14 is a flowchart showing an example of the flow of processing performed by the demand forecasting apparatus.

In Step S11, the sales-increasing product detector 41 of the controller 21 determines whether there is a product whose number of sales tends to increase. In a case where the demand forecasting unit 46 determines that there is a product whose number of sales tends to increase (Yes in Step S11), the processing of the controller 21 shifts to Step S12. On the other hand, the demand forecasting unit 46 determines that there is no product whose number of sales tends to increase (No in Step S11), the processing of the controller 21 shifts to Step S16.

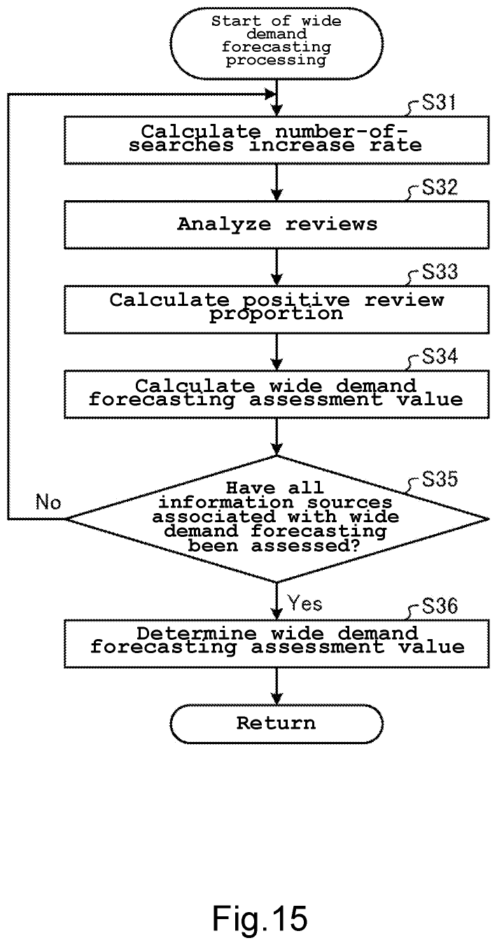

In a case where the demand forecasting unit 46 determines that there is a product whose number of sales tends to increase (Yes in Step S11), the demand forecasting unit 46 of the controller 21 performs, in Step S12, wide demand forecasting processing of determining whether wide demand for the product whose number of sales tends to increase can be expected. A flow of processing of the wide demand forecasting will be described later (see FIG. 15).

Subsequently, in Step S13, the demand forecasting unit 46 determines whether the calculated wide demand forecasting assessment value 67 is equal to or higher than a threshold. In a case where the demand forecasting unit 46 determines that the wide demand forecasting assessment value 67 is equal to or higher than the threshold (Yes in Step S13), the processing of the controller 21 shifts to Step S14. On the other hand, in a case where the demand forecasting unit 46 determines that the wide demand forecasting assessment value 67 is not equal to or higher than the threshold (No in Step S13), the processing of the controller 21 shifts to Step S15.

In a case where the demand forecasting unit 46 determines that the wide demand forecasting assessment value 67 is equal to or higher than the threshold (Yes in Step S13), the demand forecasting unit 46 determines in Step S14 that there is wide demand for the product of interest. Then, the processing of the controller 21 shifts to Step S21.

On the other hand, in a case where the demand forecasting unit 46 determines that the wide demand forecasting assessment value 67 is not equal to or higher than the threshold (No in Step S13), the demand forecasting unit 46 determines in Step S15 that there is no demand for the product of interest. Then, the controller 21 of the demand forecasting apparatus 12 terminates the processing of FIG. 14.

On the other hand, in a case where the demand forecasting unit 46 determines in Step S11 that there is no product whose number of sales tends to increase (No in Step S11), the sales-increasing product detector 41 of the controller 21 determines in Step S16 whether there is a product whose number of sales tends to increase with respect to the specified users. In a case where the demand forecasting unit 46 determines that there is a product whose number of sales tends to increase with respect to the specified users (Yes in Step S16), the processing of the controller 21 shifts to Step S17. On the other hand, in a case where the demand forecasting unit 46 determines that there is no product whose number of sales tends to increase with respect to the specified users (No in Step S16), the processing of the controller 21 shifts to Step S20.

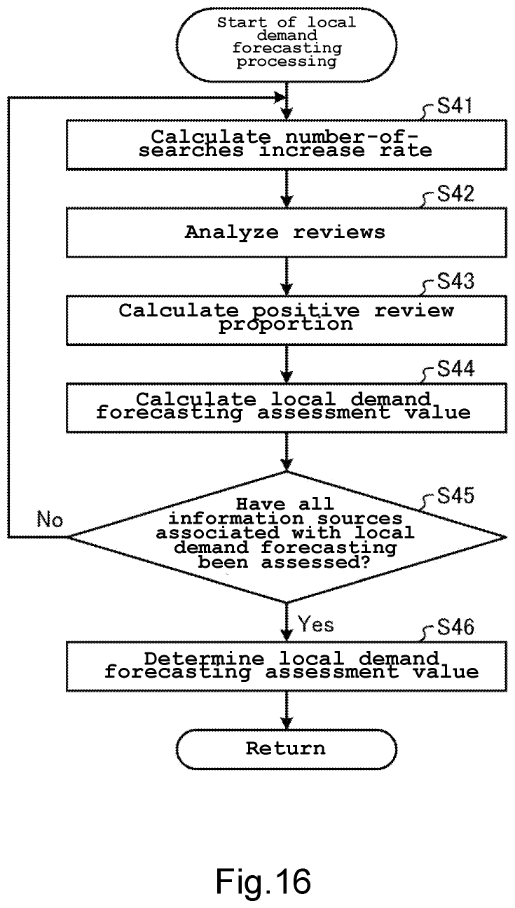

In a case where the demand forecasting unit 46 determines that there is no product whose number of sales tends to increase with respect to the specified users (Yes in Step S16), the demand forecasting unit 46 of the controller 21 performs, in Step S17, local demand forecasting processing of determining whether the demand for the product whose number of sales tends to increase in the specified region can be expected. A flow of processing of the local demand forecasting will be described later (see FIG. 16).

Subsequently, in Step S18, the demand forecasting unit 46 determines whether the calculated local demand forecasting assessment value 68 is equal to or higher than a threshold. In a case where the demand forecasting unit 46 determines that the local demand forecasting assessment value 68 is equal to or higher than the threshold (Yes in Step S18), the processing of the controller 21 shifts to Step S19. On the other hand, in a case where the demand forecasting unit 46 determines that the local demand forecasting assessment values 68 is not equal to or higher than the threshold (No in Step S18), the processing of the controller 21 shifts to Step S20.

In a case where the demand forecasting unit 46 determines that the local demand forecasting assessment value 68 is equal to or higher than the threshold (Yes in Step S18), the demand forecasting unit 46 determines in Step S19 that there is no local demand for the product of interest. Then, the processing of the controller 21 shifts to Step S21.

On the other hand, in a case where the demand forecasting unit 46 determines that the local demand forecasting assessment values 68 is not equal to or higher than the threshold (No in Step S18), the demand forecasting unit 46 determines in Step S20 that there is no demand for the product of interest. Then, the controller 21 of the demand forecasting apparatus 12 terminates the processing of FIG. 14.

Moreover, after the determination in Step S14 or S19, the demand forecasting unit 46 of the controller 21 generates, in Step S21, the wide demand forecasting screen 90 or the local demand forecasting screen 98 that is output information indicating the determination result.

In Step S22, the demand forecasting unit 46 of the controller 21 determines whether the user has made an instruction to display the output information indicating the determination result on the product order screen 80. Specifically, the demand forecasting unit 46 determines whether the user has pressed the wide demand increase mark 83 indicating that there is wide demand or the local demand increase mark 84 indicating that there is local demand on the product order screen 80. In a case where the demand forecasting unit 46 determines that the user has made the instruction to display the output information (Yes in Step S22), the processing of the controller 21 shifts to Step S23. On the other hand, in a case where the demand forecasting unit 46 determines that the user has not made the instruction to display the output information (No in Step S22), the controller 21 of the demand forecasting apparatus 12 terminates the processing of FIG. 14.

(Flow of Processing of Wide Demand Forecasting)

The flow of processing of the wide demand forecasting will be described with reference to FIG. 15. FIG. 15 is a flowchart showing an example of the flow of processing the wide demand forecasting.

In Step S31, the number-of-searches acquisition unit 42 of the controller 21 acquires the number of searches of the product whose number of sales has been in Step S11 (see FIG. 14) determined to tend to increase with respect to one of the preset first information sources 14. Then, the number-of-searches acquisition unit 42 calculates a number-of-searches increase rate 64 (see FIG. 9).

In Step S32, the review classification analyzer 43 of the controller 21 analyzes whether a review posted to the first information sources 14 about the product of interest is positive, negative, or neutral.

Subsequently, in Step S33, the review classification analyzer 43 of the controller 21 calculates positive review proportion 65 (see FIG. 9) about the product of interest.

In Step S34, the demand forecasting unit 46 of the controller 21 calculates a wide demand forecasting assessment value 67 (see FIG. 9) associated with the product of interest with respect to the first information source 14 of interest.

In Step S35, the demand forecasting unit 46 determines whether the demand forecasting unit 46 has assessed all the first information sources 14. In a case where the demand forecasting unit 46 determines that the demand forecasting unit 46 has assessed all the first information sources 14 (Yes in Step S35), the processing of the controller 21 shifts to Step S36. On the other hand, in a case where the demand forecasting unit 46 determines that the demand forecasting unit 46 has not assessed all the first information sources 14 (No in Step S35), the processing of the controller 21 returns to Step S31. Then, the controller 21 analyzes a different first information source 14.

In a case where the demand forecasting unit 46 determines that the demand forecasting unit 46 has assessed all the first information sources 14 (Yes in Step S35), the demand forecasting unit 46 determines in Step S36 a demand forecasting assessment value 71 (see FIG. 9) by adding up the wide demand forecasting assessment values 67 calculated with respect to all the first information sources 14. Then, the processing of the controller 21 returns to a main routine (FIG. 14).

(Flow of Processing of Local Demand forecasting)

The flow of processing of the local demand forecasting will be described with reference to FIG. 16. FIG. 16 is a flowchart showing an example of the flow of processing of the local demand forecasting.

In Step S41, the number-of-searches acquisition unit 42 of the controller 21 acquires the number of searches of the product whose number of sales has been in Step S16 (see FIG. 14) determined to tend to increase with respect to one of the preset second information sources 15. Then, the number-of-searches acquisition unit 42 calculates a number-of-searches increase rate 64 (see FIG. 10).

In Step S42, the review classification analyzer 43 of the controller 21 analyzes whether a review posted to the second information sources 15 about the product of interest is positive, negative, or neutral.

Subsequently, in Step S43, the review classification analyzer 43 of the controller 21 calculates positive review proportion 65 (see FIG. 10) about the product of interest.

In Step S44, the demand forecasting unit 46 of the controller 21 calculates a local demand forecasting assessment value 68 (see FIG. 10) associated with the product of interest with respect to the second information source 15 of interest.

In Step S45, the demand forecasting unit 46 determines whether the demand forecasting unit 46 has assessed all the second information sources 15. In a case where the demand forecasting unit 46 determines that the demand forecasting unit 46 has assessed all the second information sources 15 (Yes in Step S45), the processing of the controller 21 shifts to Step S46. On the other hand, in a case where the demand forecasting unit 46 determines that the demand forecasting unit 46 has not assessed all the second information sources 15 (No in Step S45), the processing of the controller 21 returns to Step S41. Then, the controller 21 analyzes a different second information source 15.

In a case where the demand forecasting unit 46 determines that the demand forecasting unit 46 has assessed all the second information sources 15 (Yes in Step S45), the demand forecasting unit 46 of the controller 21 determines in Step S46 a demand forecasting assessment value 71 by adding up the local demand forecasting assessment values 68 calculated with respect to all the second information sources 15 and the number-of-purchases increase rate 66 of the specified users (see FIG. 10). Then, the processing of the controller 21 returns to a main routine (FIG. 14).

### Actions and Effects of Embodiment

As described above, the controller 21 (information processing apparatus) of the demand forecasting apparatus 12 according to the present embodiment operates as the sales-increasing product detector 41 (detector), the number-of-searches acquisition unit 42 (acquisition unit), the review classification analyzer 43 (calculator), the demand forecasting unit 46, and the forecasting result output unit 47 (output unit) by operating the control program 26. Then, the sales-increasing product detector 41 (detector) detects the first product (product) whose number of sales tends to increase widely. The number-of-searches acquisition unit 42 (acquisition unit) acquires the number of searches of the first product from the preset first information sources 14. The review classification analyzer 43 (calculator) calculates a proportion of positive reviews about the first product from the reviews sent to the first information sources 14. The demand forecasting unit 46 determines whether wide demand for the first product can be expected on the basis of the number of searches acquired by the number-of-searches acquisition unit 42 and the proportion of positive reviews calculated by the review classification analyzer 43. The forecasting result output unit 47 (output unit) outputs the determination result of the demand forecasting unit 46. Thus, a product for which future wide demand can be expected to increase can be early forecasted.

Moreover, in the demand forecasting apparatus 12 (information processing apparatus) according to the present embodiment, the sales-increasing product detector 41 of the controller 21 (detector) further detects the second product (product) whose number of sales tends to increase with respect to the specified users in the specified region. The number-of-searches acquisition unit 42 of the controller 21 (acquisition unit) further acquires the number of searches of the second product from the preset second information sources 15 that transmit the information associated with the specified region. The review classification analyzer 43 (calculator) further calculates the proportion of positive reviews about the second product from the reviews sent to the second information sources 15. The demand forecasting unit 46 of the controller 21 further determines whether demand for the second product in the specified region can be expected on the basis of the number of searches acquired by the number-of-searches acquisition unit 42 and the proportion of positive reviews calculated by the review classification analyzer 43. Thus, a product for which future demand in the specified region can be expected to increase can be early forecasted.

Moreover, in the demand forecasting apparatus 12 (information processing apparatus) according to the present embodiment, the forecasting result output unit 47 (output unit) of the controller 21 outputs the determination reason 91 from the demand forecasting unit 46, the product sales transition 92, the number-of-searches transition 93, and the review classification breakdown 94 including the proportion of positive reviews. Thus, the user can know the reason why the demand forecasting unit 46 has determined that the demand can be expected.

Moreover, in the demand forecasting apparatus 12 (information processing apparatus) according to the present embodiment, the forecasting result output unit 47 (output unit) of the controller 21 outputs to the product order screen 80 the determination result as to whether the demand for the product can be expected in association with the product. Thus, operability of the operation for ordering work can be improved because a person in charge who makes an instruction about the number of orders of a product can easily recognize a product for which demand will increase.

Moreover, in the demand forecasting apparatus 12 (information processing apparatus) according to the present embodiment, the review classification analyzer 43 (calculator) of the controller 21 operates as the review extractor 44 (extractor) and the review contents identifying unit 45 (identifying unit). Then, the review extractor 44 (extractor) extracts the reviews associated with the product. The review contents identifying unit 45 (identifying unit) identifies whether the reviews are positive, negative, or neutral by parsing the review extracted by the review extractor 44. Thus, the user can reliably analyze whether the reviews about the product, which have been sent to the information sources, are positive.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claimed is:

1. An information processing apparatus that forecasts demand for a product, comprising:
a storage device that stores product sales data, the product sales data including data necessary for comparing the number of current product sales with the number of past product sales with respect to a plurality of products;
a communication interface that accesses a preset first information source, the first information source being an information source where a plurality of users is able to search for a product and post reviews about the product; and
a controller configured to
detect, on a basis of the product sales data, a product whose number of sales tends to increase in a wide area by comparing the number of current product sales with the number of past product sales,
acquire the number of searches of the detected product from the first information source via the communication interface,
calculate a proportion of positive reviews about the detected product in the reviews posted to the first information source,
determine whether demand for the product in the wide area can be expected on a basis of the acquired number of searches and the calculated proportion of the positive reviews, and
output a result of the determination.

2. The information processing apparatus according to claim 1, wherein
the controller further detects, on a basis of the product sales data, a product whose number of sales tends to increase with respect to specified users in a specified region.

3. The information processing apparatus according to claim 1, wherein
the communication interface further accesses a second information source that transmits information associated with a preset specified region, the second information source being an information source where a plurality of specified users in the specified region is able to search for a product and post reviews about the product, and
the controller acquires the number of searches of the detected product from the second information source via the communication interface.

4. The information processing apparatus according to claim 1, wherein
the communication interface further accesses a second information source that transmits information associated with a preset specified region, the second information source being an information source where a plurality of specified users in the specified region is able to search for a product and post reviews about the product, and
the controller
detects, on a basis of the product sales data, a product whose number of sales tends to increase with respect to the specified users in the specified region, and
acquires the number of searches of the detected product from the second information source.

5. The information processing apparatus according to claim 1, wherein
the communication interface further accesses a second information source that transmits information associated with a preset specified region, the second information source being an information source where a plurality of specified users in the specified region is able to search for a product and post reviews about the product, and
the controller calculates a proportion of positive reviews about the detected product in the reviews posted to the second information source.

6. The information processing apparatus according to claim 1, wherein
the communication interface further accesses a second information source that transmits information associated with a preset specified region, the second information source being an information source where a plurality of specified users in the specified region is able to search for a product and post reviews about the product, and
the controller
detects, on a basis of the product sales data, a product whose number of sales tends to increase with respect to the specified users in the specified region and acquires the number of searches of the detected product from the second information source,
further calculates a proportion of positive reviews about the detected product in the reviews posted to the second information source, and
determines whether demand for the detected product in the specified region can be expected on a basis of the acquired number of searches and the calculated proportion of the positive reviews.

7. The information processing apparatus according to claim 1, wherein
the controller outputs a reason for the determination, a transition of sales, a transition of the number of searches, and a proportion of positive reviews.

8. The information processing apparatus according to claim 1, wherein
the controller outputs a determination result as to whether demand for the detected product can be expected to an order screen for the detected product in association with the product.

9. The information processing apparatus according to claim 1, wherein
the controller
extracts the review associated with the detected product from the reviews posted to the first information source, and
identifies whether the extracted review is positive, negative, or neutral by parsing the extracted review.

10. An information processing method for an information processing apparatus that forecasts demand for a product, comprising:
storing product sales data in a storage device, the product sales data including data necessary for comparing the number of current product sales with the number of past product sales with respect to a plurality of products;
accessing a preset first information source via a communication interface, the first information source being an information source where a plurality of users is able to search for a product and post reviews about the product;
detecting a product whose number of sales tends to increase in a wide area by comparing the number of current product sales with the number of past product sales on a basis of the product sales data;
acquiring the number of searches of the detected product from the first information source;
calculating a proportion of positive reviews about the detected product from the reviews posted to the first information source;
determining whether demand for the detected product in the wide area can be expected on a basis of the acquired number of searches and the calculated proportion of the positive reviews; and
outputting a result of the determination.
